(19) United States
(12) Patent Application Publication
(10) Pub. No.: US 2020/0102915 A1
(43) Pub. Date: Apr. 2, 2020

(54) CARBURETION SYSTEM

(71) Applicant: Robert Paul Manhart, Ft. Myers, FL (US)

(72) Inventor: Robert Paul Manhart, Ft. Myers, FL (US)

(21) Appl. No.: 16/369,448

(22) Filed: Mar. 29, 2019

Related U.S. Application Data
(60) Provisional application No. 62/740,295, filed on Oct. 2, 2018.

(51) Int. Cl. F02M 9/08; F02D 9/10; F02M 19/08

(52) U.S. Cl. CPC F02M 9/085; F02D 9/16; F02M 19/08; F02D 9/1045

(57) ABSTRACT

An improved carburetion system is provided. The carburetion system embodied in the present invention relocates the throttle plate anterior to venturi in an oversized throttle plate bore. By removing the throttle plate and shaft and its inherent interference imposed on the air/fuel mixture flow in the post-venturi chamber, the present invention delivers an increased cubic volume of uniform turbulent air/fuel mixture flow to the intake manifold. As a result, increasing the power at full throttle operation relative to the prior art.

### CROSS-REFERENCE TO RELATED APPLICATION

This application claims the benefit of priority of U.S. provisional application No. 62/740,295, filed 2 Oct. 2018, the contents of which are herein incorporated by reference.

### BACKGROUND OF THE INVENTION

The present invention relates to carburetion systems and, more particularly, to a carburetion system improved by relocating the throttle plate anterior to the venturi in an oversized throttle plate bore sized to accommodate an enlarged throttle plate relative to the prior art.

Current carbureted engines are expected to operate over a calculated RPM (revolutions per minute) range. Because of this the carburetor is not optimal at any RPM because it embodies a compromise that necessarily anticipates operation at other RPMs, particularly idle RPMs.

A carbureted engine requires a throttle plate to manipulate air/fuel mixture for the venturi during the intake cycle, and subsequently to control RPM's over a range that the engine can operate at its idle RPM as well as through higher RPMs. The throttle plate is not needed at maximum RPM's yet remains present and thus interferes and disrupts the maximum air/fuel flow being supplied to the intake manifold, making the air/fuel flow suboptimal, more turbulent. All else being equal, it would be ideal if the throttle plate was nonexistent at max RPMs, but the prior art does not anticipate this absence. In short, throttle plate location in the prior art prohibits maximum fuel/air mixture at high end RPM's and creates more chaotic, turbulent air flow at the intake manifold.

Furthermore, because the throttle plate in the prior art is after the venturi (and before the intake manifold) it limits the permissible size for satisfactory venturi operation because current carburetion systems necessarily consist of the same size throttle plate housing cross section for both the throttle valve and post venturi chamber.

As can be seen, there is a need for a carburetion system improved by relocating the throttle plate anterior to the venturi in an oversized throttle plate bore, allowing for larger and less disturbed air/fuel cubic flow to the intake manifold. As a result, the present invention enables carburetor optimization not presently available for high end RPMs, as well as improved, more uniform flow of fuel/air mixture at all compromised RPM ranges and significantly more air fuel mixture at the top RPMs through effectively eliminating any influence of a throttle plate and throttle plate shaft. Whereby, the venturi—at its relatively faster velocity —“combs” the post-throttle-plate airflow so it more closely approximates uniform flow.

By relocating and enlarging the throttle plate and throttle plate shaft, the present invention—besides improving flow at the intake manifold—effectively eliminates the throttle plate from having any deleterious effect on the volume and flow characteristics of the fuel/air mix. In effect, at maximum RPM, the venturi and intake manifold flow are unaffected by a throttle plate. This accomplishment is achieved by locating a significantly enlarged throttle plate and throttle plate housing before the venturi. This said enlargement is significantly bigger than the subsequent carburetor bore, yet the choke plate still functions as required when needed from starting to idling to intermediate RPM ranges.

### SUMMARY OF THE INVENTION

In one aspect of the present invention, an improved carburetion system, includes the following: a carburetor body providing in series upstream to downstream: an enlarged pre-venturi chamber; a venturi; and a post-venturi chamber adapted to be fluidly couplable to an intake manifold; a bore extending through the carburetor body; and an enlarged throttle plate located in a portion of the bore associated with the pre-venturi chamber, upstream from the venturi.

In another aspect of the present invention, a method of improving full throttle operation of a prior art carburetion system includes the following process: removing a throttle plate and throttle plate shaft of said prior art carburetion system; sealing any openings said removal has created; manufacturing a larger throttle plate; building a suitable-sized throttle plate housing and a throttle plate shaft operatively associated with said larger throttle plate; and modifying the prior art carburetion system for mounting upstream of an associated venturi said throttle plate housing and throttle plate shaft operatively associated with said larger throttle plate.

These and other features, aspects and advantages of the present invention will become better understood with reference to the following drawings, description and claims.

### BRIEF DESCRIPTION OF THE DRAWINGS

FIG. 1 is a section of an exemplary embodiment of the present invention;

FIG. 2 is a view of the prior art, showing carburetor shaft with a throttle plate in the open position, illustrating the post venturi mixed/compound turbulence generated by the throttle plate;

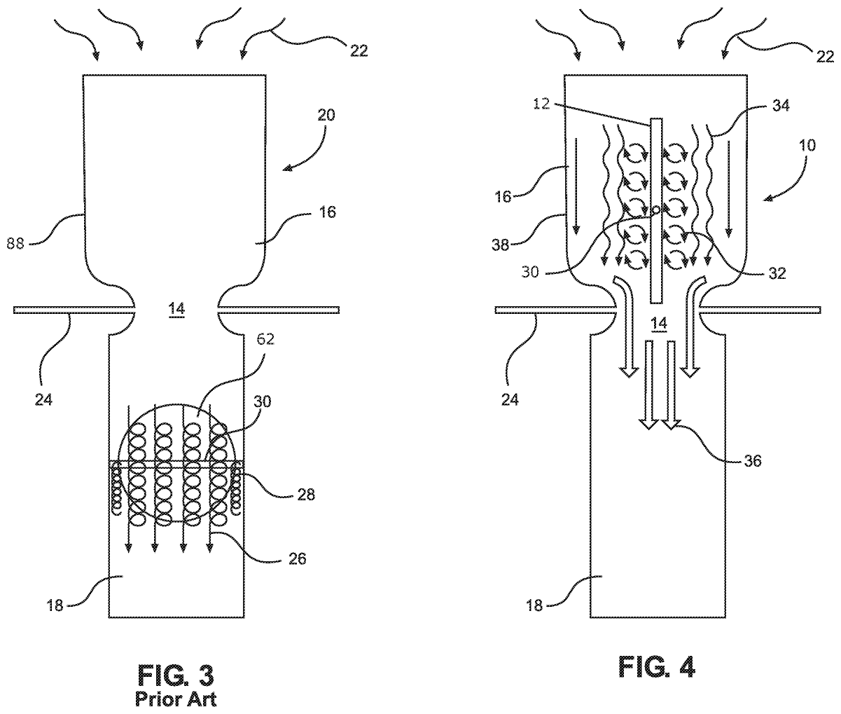

FIG. 3 is an internal view of the prior art, showing carburetor shaft with a throttle plate in the open position, illustrating the post venturi mixed/compound turbulence generated by the throttle plate shaft;

FIG. 4 is a section view of an exemplary embodiment of the present invention, shown in operation, illustrating the improved uniform turbulent flow of the increased fuel/air mixture; and

FIG. 5A-5C are carburetor calculations regarding the diameter and area of the post-venturi and pre-venturi chambers for the present invention.

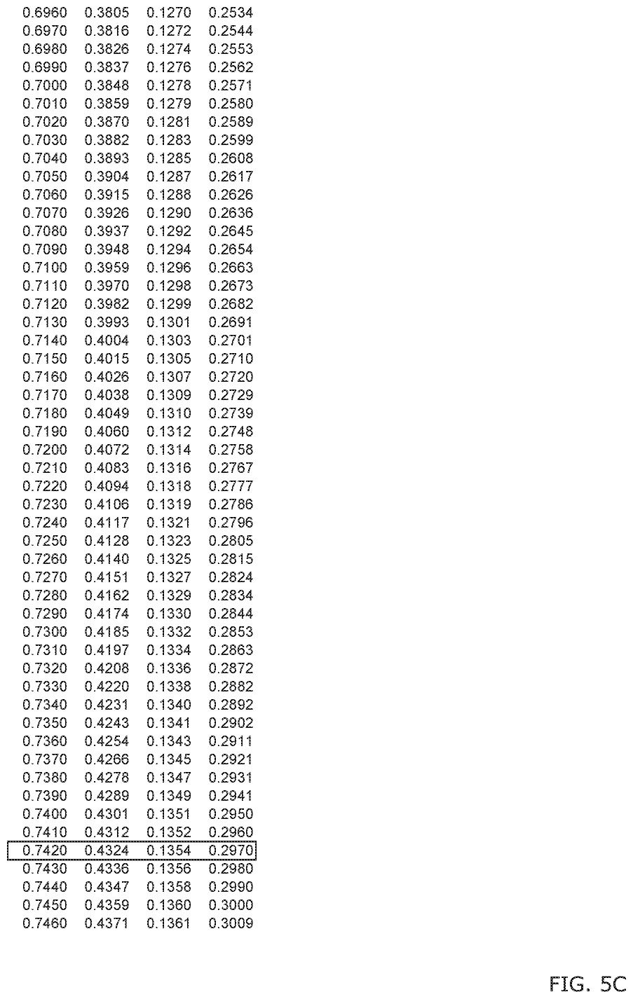

### ITEMIZED PARTS LIST

10: is the Improved Carburetion System
12: is the Enlarged Throttle Plate
14: is the Venturi
16: is the Pre-Venturi Chamber
18: is the Post-Venturi Chamber
20: is an Example of a Standard Carburetor
22: is Ambient Air
24: is the Carbureted Fuel Insertion Assembly
26: is Throttle Plate Generated Mixed or Compound Turbulence
28: is Throttle Shaft Generated Mixed or Compound Turbulence
30: is the Throttle Plate Shaft
32: are Friction/Obstruction Eddies
34: is Mixed or Compound Turbulent Flow
36: is Uniform Turbulent Flow
38: is the Oversized Throttle Plate Housing
50: is the Bore
62: is the Prior Art Throttle Plate
88: is the Prior Art Throttle Plate Housing

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a carburetion system improved by locating an enlarged throttle plate anterior to venturi in an oversized throttle plate bore. By removing the throttle plate and shaft from the post-venturi chamber, and its inherent interference imposed on the air/fuel mixture flow therein, the present invention delivers an increased cubic volume of uniform turbulent air/fuel mixture flow to the intake manifold. As a result, increasing the power at full throttle operation relative to the prior art.

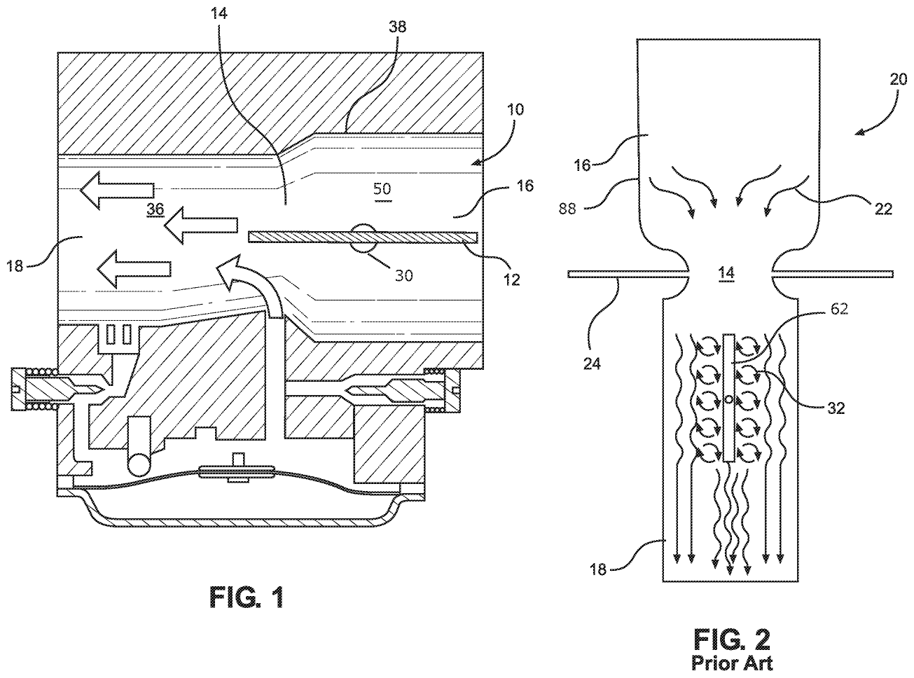

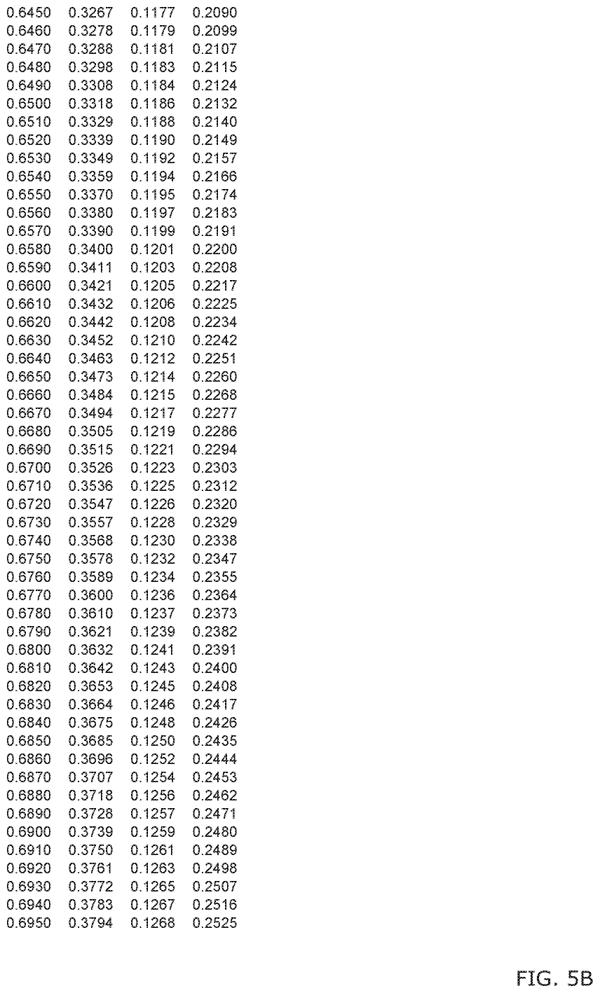

Referring to FIGS. 1 and 4, the present invention may include an improved carburetion system 10 having a carburetor body providing a bore 50 extending therethrough. The bore 50 includes a pre-venturi chamber 16, a venturi 14, and a post-venturi chamber 18 disposed in series, respectively. The post-venturi chamber 18 is fluidly coupled to an intake manifold. The present invention locates an enlarged throttle plate 12 anterior to the venturi 14 in an oversized throttle plate housing 38 disposed in a pre-venturi chamber 16. The enlarged throttle plate 12 is rotatably mounted on a throttle plate shaft 30 therein. The oversized throttle plate housing 38 (pre-venturi chamber 16) is significantly larger in cross section than the post-venturi chamber 18 leading to the intake manifold; approximately 0.745 inches (pre-venturi chamber 16) to 0.615 inches (post-venturi chamber 18) in diameter, respectively, and a resulting cross-sections area of 0.435 inches squared to 0.297 inches squared, respectively. Or in other words, approximately 15 to 25% smaller by diameter and approximately 40% to 55% smaller by area, respectively.

Referring to FIG. 4, ambient air 22 is drawn into the oversized throttle plate housing 38 within the pre-venturi chamber 16. The ambient air 22 experiences disruption as it encounters the enlarged throttle plate 12 and throttle plate shaft 30 within the pre-venturi chamber 16. This disruption is manifested in the form of eddies 32 and mixed or compound turbulent flow 34. After the airflow passes beyond the enlarged throttle plate 12 it encounters the venturi 14 and carbureted fuel insertion assembly 24 and enters the post-venturi chamber 18, without interference of the enlarged throttle plate 12, resulting in a more uniform turbulent flow 36, which in turn is fluidly communicated to the intake manifold. The enlarged throttle plate 12 and the oversized throttle plate housing 38 located in line but before the venturi 14 permits more fuel/air cubic flow through the post-venturi chamber 18.

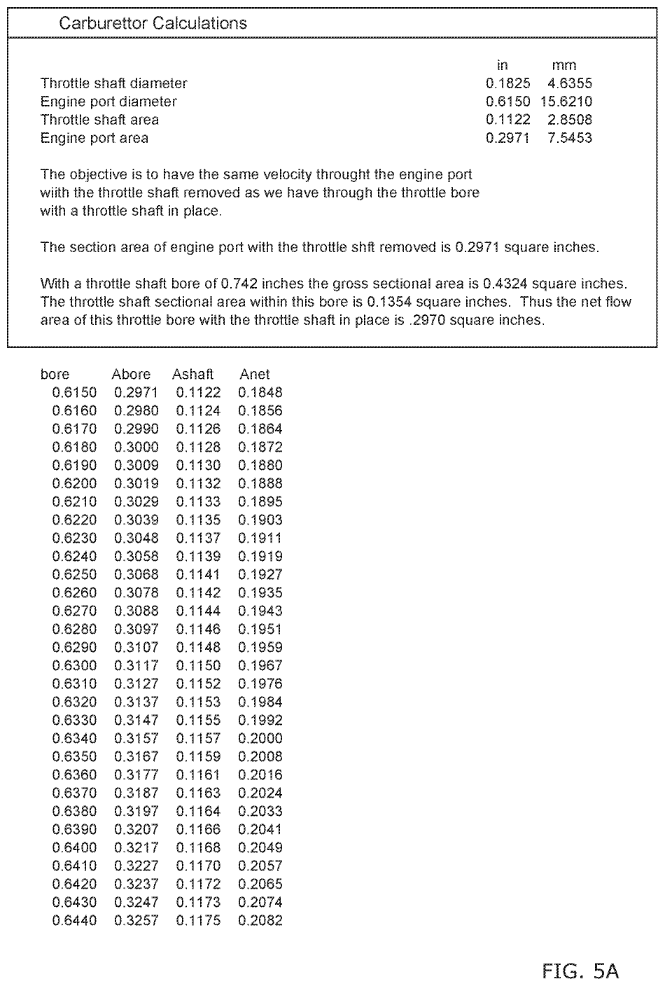

In short, the present invention enables more uniform turbulent flow 36 entering the post-venturi chamber 18. Now compare this to the prior art 20, as illustrated in FIG. 3. In the prior art 20, within the post-venturi chamber 18, there exists generation of mixed or compound turbulent flow 34; specifically, throttle plate-generated mixed or compound turbulence 26 and throttle shaft-generated mixed or compound turbulence 28, which is immediately passed to the intake manifold.

Furthermore, locating the enlarged throttle plate 12 and shaft 30 prior to the venturi 14 prevents size limitations that otherwise would be relevant to the enlarged throttle plate 12 size if it is positioned after the venturi 14. The aforementioned size limitations dictated by the prior art seriously limit the maximum cubic flow of air/fuel associated with high-end RPM needs.

Another advantage of the present invention is that it prevents even momentary accumulation of fuel condensate on the enlarged throttle plate 12 or throttle plate shaft 30, which occurs on the prior art throttle plate 62 and the prior throttle plate shaft present in the prior art 20, as illustrated by comparing FIG. 3 in view of FIG. 4. In the prior art 20, such fuel condensation is possible, but impossible in the present invention of FIG. 4, as the fuel is introduced after the enlarged throttle plate 12.

A method of manufacturing the improved carburetion system 10 may include the following steps: recalculating optimum enlarged throttle plate 12 size suitable for a pre-venturi throttle plate location; building a suitable sized (oversized) housing 38 and throttle plate shaft 30 for said enlarged throttle plate 12; attaching the assembly embodied by the present invention above the venturi, appropriately sealing with air tight gasket or other methods.

The easiest way to make the present invention would be to acquire a carburetor built on the prior art 20, remove its prior art throttle plate 62 and throttle plate shaft 30 and seal any openings this removal has created. Also, a manufacturer/installer may want to replace the prior art throttle plate housing 88 with the appropriate oversized throttle plate housing 38, and so manufacture a larger enlarged throttle plate 12 and a suitably oversized throttle plate housing 38, and modify the old carburetor barrel to mount the enlarged throttle plate 12 and suitably oversized throttle plate housing 38.

Which leads to another advantage: the present invention is simpler and less expensive to manufacture and does not incorporate additional “wear parts” found in the prior art, for example a cylindrical tubular throttle body, a fuel metering rod, or apparatus dedicated for the removal of obstructions—particularly at full throttle. Any additional parts immediately prior to the intake manifold interrupts the air/fuel flow and lessens the cubic volume of uniform turbulent flow to the intake manifold.

The decline in use of carburetors was dictated not by some significant inferiority as compared to fuel injection systems, but because carburetion was not compatible with the requirements of catalytic converters which require more precise control of the amount of oxygen remaining in the exhaust gases. However, there are numerous instances where fuel injection is not practical due to concerns regarding size and expense. Current situations where carburetion remains popular include small engines for snowmobiles, chainsaws, generators, lawn mowers, rototillers, edger's, leaf blowers, motorcycles, hobby applications and limited use in aviation, or anywhere where a venturi 14 and control of fluids is viable. Mounting a carburetor incorporating the design of the present invention, specifically with the enlarged throttle plate 12 and suitably oversized throttle plate housing 38 located in a superior position to the venturi 14, could be a boon for such applications.

Specifically, the present invention is well suited for racing (i.e., full throttle operation) by providing a significant increase in power, as the power output of internal combustion engines is directly proportional to the volume of the air/fuel mixture delivered. any pressure drop occurring ahead of the cylinder due to friction and/or turbulence or intermittent fuel condensate on a throttle plate can be expected to result in a lower fuel/air delivery subject to compression, thus decreasing the power output.

It should be understood, of course, that the foregoing relates to exemplary embodiments of the invention and that modifications may be made without departing from the spirit and scope of the invention as set forth in the following claims.

What is claimed is:

1. A carburetion system, comprising:
a carburetor body providing in series upstream to downstream:
an enlarged pre-venturi chamber;
a venturi; and
a post-venturi chamber adapted to fluidly couplable to an intake manifold;
a bore extending through the carburetor body; and
an enlarged throttle plate located a portion of the bore associated with the pre-venturi chamber, upstream from the venturi.

2. The carburetion system of claim 1, further comprising a throttle plate housing disposed in the pre-venturi chamber; and the throttle plate housing provides a throttle plate shaft to which the throttle plate is rotatably mounted.

3. The carburetion system of claim 2, wherein the throttle plate housing is significantly larger in cross section area than the post-venturi chamber by approximately forty to fifty-five percent.

4. The carburetion system of claim 3, wherein the throttle plate has a cross-sectional area of approximately 0.4 inches squared.

5. A method of improving full throttle operation of a prior art carburetion system, comprising:
removing a throttle plate and throttle plate shaft of said prior art carburetion system;
sealing any openings said removal has created;
manufacturing an enlarged throttle plate;
building a suitable-sized throttle plate housing and a throttle plate shaft operatively associated with said enlarged throttle plate; and
modifying the prior art carburetion system for mounting upstream of an associated venturi said throttle plate housing and throttle plate shaft operatively associated with said enlarged throttle plate.
